(19) United States
(12) Patent Application Publication
(10) Pub. No.: US 2026/0006168 A1
(43) Pub. Date: Jan. 1, 2026

(54) STEREOSCOPIC IMAGE DISPLAY DEVICE

(71) Applicant: Lixel Inc., Hsinchu City (TW)

(72) Inventors: CHUN-HSIANG YANG, Hsinchu City (TW); CHIH-HUNG TING, New Taipei City (TW); CHIH-WEI SHIH, Hsinchu City (TW); HSIN-YOU HOU, New Taipei City (TW)

(21) Appl. No.: 18/892,628

(22) Filed: Sep. 23, 2024

(30) Foreign Application Priority Data
Jun. 27, 2024 (TW) 113123920

(51) Int. Cl. H04N 13/305; G02B 27/00

(52) U.S. Cl. CPC H04N 13/305; G02B 27/0012

(57) ABSTRACT

A stereoscopic image display device includes a flat panel display unit, a lens array unit, and a directional structure. The flat panel display unit has a display surface configured to display a plurality of element images. The lens array unit is disposed at intervals on a side of the display surface and includes a plurality of condenser lenses. The directional structure includes a plurality of partition walls, which are inclined at different angles between the flat panel display unit and the lens array unit, and define a plurality of isolated spaces.

### CROSS-REFERENCE TO RELATED PATENT APPLICATION

This application claims the benefit of priority to Taiwan Patent Application No. 113123920, filed on Jun. 27, 2024. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a stereoscopic image display device, and more particularly to a stereoscopic image display device based on an extended coding pitch algorithm.

### BACKGROUND OF THE DISCLOSURE

Referring to FIGS. 1 and 2, in the related art, a conventional stereoscopic image display device 100′ includes a flat panel display unit a, a lens array unit b, and a partition unit c disposed between the flat panel display unit a and the lens array unit b.

The flat panel display unit a has a display surface al capable of producing an integral image. The lens array unit b includes a plurality of lenses b1 designed to focus the integral image for producing a stereoscopic image.

However, the conventional stereoscopic image display device 100′ has certain limitations under specific viewing conditions.

In particular, when viewed from short distances or wide viewing angles, the conventional stereoscopic image display device often exhibits issues of image stepping or crosstalk, resulting in a reduced effective viewing range (as illustrated by the limited visual area EZ′ in FIG. 2), thereby limiting the application scenarios of the device. For example, when a user views a stereo image from a wide angle (e.g., in an X direction position deviating significantly from a central axis of the display) or a close distance (e.g., less than 4 meters), an image quality may be severely degraded, thereby affecting the visual experience and restricting practical applications of the conventional stereoscopic image display device.

### SUMMARY OF THE DISCLOSURE

In response to the above-referenced technical inadequacies, the present disclosure provides a stereoscopic image display device.

In order to solve the above-mentioned problems, one of the technical aspects adopted by the present disclosure is to provide a stereoscopic image display device that includes a flat panel display unit, a lens array unit, and a directional structure. The flat panel display unit has a display surface configured to display a plurality of element images. The lens array unit is disposed at intervals on a side of the display surface and includes a plurality of condenser lenses. The directional structure includes a plurality of partition walls. The plurality of partition walls are inclined at different angles between the flat panel display unit and the lens array unit, and define a plurality of isolated spaces.

In one of the possible or preferred embodiments, inclined degrees of the plurality of partition walls gradually increases relative to a central axis of the display surface along an extension direction away from the central axis.

In one of the possible or preferred embodiments, the plurality of isolated spaces respectively correspond to the plurality of condenser lenses, and an end of each of the partition walls close to the lens array unit is directed towards a convex boundary of the corresponding condenser lens near the central axis, and a virtual extension line of each of the partition walls extending towards the lens array unit crosses the convex boundary.

In one of the possible or preferred embodiments, an end of each of the partition walls close to the flat panel display unit is disposed and abutted against the display surface, and shifted towards the extension direction away from the central axis, such that the plurality of partition walls form a plurality of shift distances, and the plurality of partition walls respectively include a plurality of included angles with the display surface.

In one of the possible or preferred embodiments, the plurality of shift distances gradually increase from the central axis towards the extension direction, and the plurality of included angles gradually decrease from the central axis towards the extension direction, such that the inclined degrees of the partition walls gradually increase towards the extension direction.

In one of the possible or preferred embodiments, a wall thickness of each of the partition walls is not greater than 300 micrometers.

In one of the possible or preferred embodiments, a width of each of the condenser lenses is defined as a lens pitch, and a width of each of the element images displayed on the display surface is defined as a coding pitch. The coding pitch is calculated based on an extended coding pitch algorithm.

In one of the possible or preferred embodiments, the coding pitch satisfies the following formula (1):

$$coding pitch {P}^{′} = \frac{\begin{matrix}( lens pitch P ) ( viewing distance V d + \\ equivalent object distance So )\end{matrix}}{viewing distance V d} . \qquad formula ( 1 )$$

P represents the the lens pitch, and P′ represents the coding pitch. The viewing distance Vd is a viewing distance for a user, and the equivalent object distance So is a distance calculated by equating one or more medium layers disposed between the lens array unit and the display surface to an air layer.

In one of the possible or preferred embodiments, the plurality of partition walls are sequentially defined as a first wall, a second wall, up to an (N−1)th wall and an Nth wall from the central axis of the display surface towards the extension direction, in which the shift distances of the plurality of partition walls are different from each other, and a shift distance Dsn of each of the partition walls satisfies the following formula (2):

$$shift distance Dsn = ( n - 1 ) ( coding pitch {P}^{′} - lens pitch P ) + \frac{( coding pitch {P}^{′} - lens pitch P )}{2} . \qquad formula ( 2 )$$

In the formula (2), n is a positive integer between 1 and N.

In one of the possible or preferred embodiments, the included angles between the plurality of partition walls and the display surface are different from each other, and an included angle θtn between each of the partition walls and the display surface satisfies the following formula (3):

$$included angle θ tn = arctan ( \frac{physical distance Dz}{shift distance Dsn} ) . \qquad formula ( 3 )$$

In the formula (3), the physical distance Dz is an actual distance from a side surface of the lens array unit facing towards the display surface to the display surface of the flat panel display unit.

In one of the possible or preferred embodiments, each of the partition walls has a visible light transmittance not greater than 10% and a light reflectance not greater than 40%.

Therefore, the stereoscopic image display device provided by the present disclosure can effectively eliminate the issues of image stepping or crosstalk in the light field system of the stereoscopic image display device by virtue of “a directional structure including a plurality of partition walls, in which the plurality of partition walls are respectively inclined at different angles between the flat panel display unit and the lens array unit, and define a plurality of isolated spaces.” In addition, the stereoscopic image display device provided by the present disclosure has expanded viewing range of the image system, improved image quality, and enhanced viewing experience for the user. The stereoscopic image display device of the present disclosure allows users to see clear and high-quality stereoscopic images even from short viewing distances or wide viewing angles.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic view of a stereoscopic image display device in a conventional art;

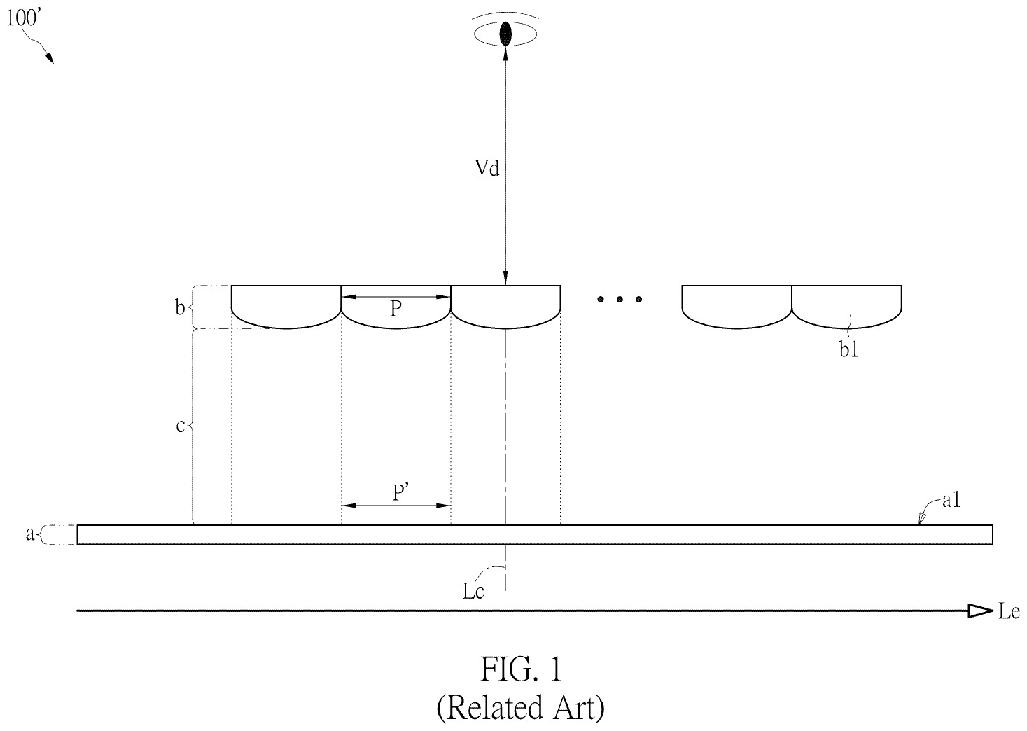

FIG. 2 is a schematic view of light field distribution of the stereoscopic image display device in the conventional art;

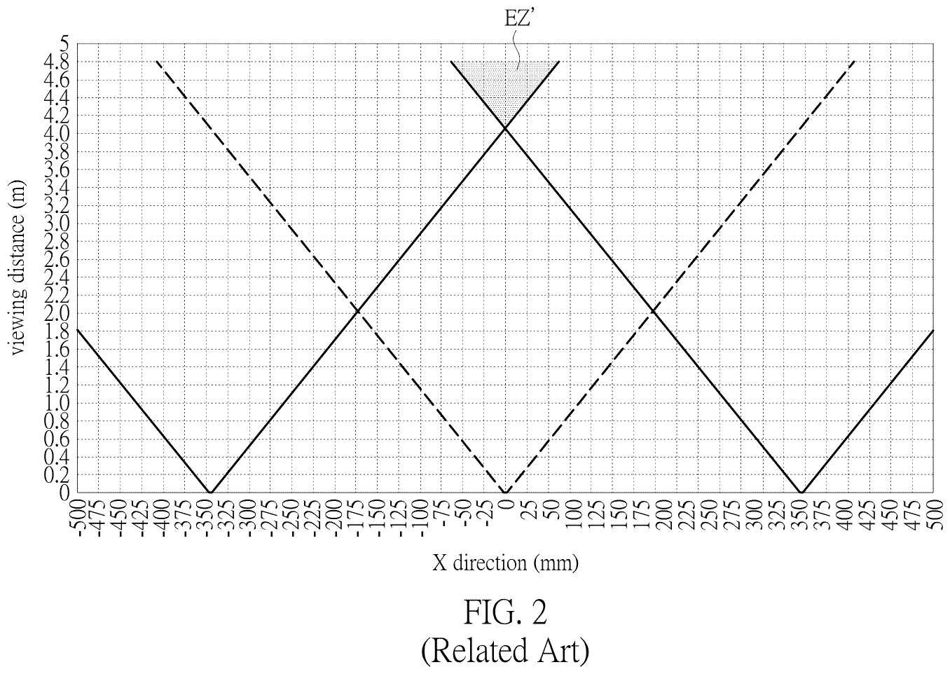

FIG. 3A is a side view of a stereoscopic image display device according to a first embodiment of the present disclosure;

FIG. 3B is another side view of the stereoscopic image display device according to the first embodiment of the present disclosure;

FIG. 4 is a perspective view of the stereoscopic image display device according to the first embodiment of the present disclosure;

FIG. 5 is a schematic view comparing a lens pitch and a coding pitch according to the first embodiment of the present disclosure;

FIG. 6 is a top view of a directional structure according to the first embodiment of the present disclosure;

FIG. 7 is a schematic view showing light field distribution of the stereoscopic image display device according to the first embodiment;

FIG. 8 is a side view of a stereoscopic image display device according to a second embodiment of the present disclosure;

FIG. 9 is a side view of a stereoscopic image display device according to a third embodiment of the present disclosure;

FIG. 10 is a side view of a stereoscopic image display device according to a fourth embodiment of the present disclosure;

FIG. 11 is a side view of a stereoscopic image display device according to a fifth embodiment of the present disclosure; and

FIG. 12 is a side view of a stereoscopic image display device according to a sixth embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

### First Embodiment

The present disclosure aims to address limitations encountered by a conventional stereoscopic image display device under specific viewing conditions. Specifically, the conventional stereoscopic image display device often exhibits image stepping or crosstalk when viewed at short distances or wide viewing angles, resulting in a reduced effective viewing range, thereby limiting application scenarios of the conventional stereoscopic image display device. For example, when a user views the conventional stereoscopic image display device from a large angle or a close distance, image quality significantly degrades, thereby affecting a visual experience for the user and reducing practicality. Therefore, the present disclosure provides an improved light field display technology to reduce the issues of image stepping or crosstalk, expand the viewing range of the image system, improve image quality, and enhance the user viewing experience.

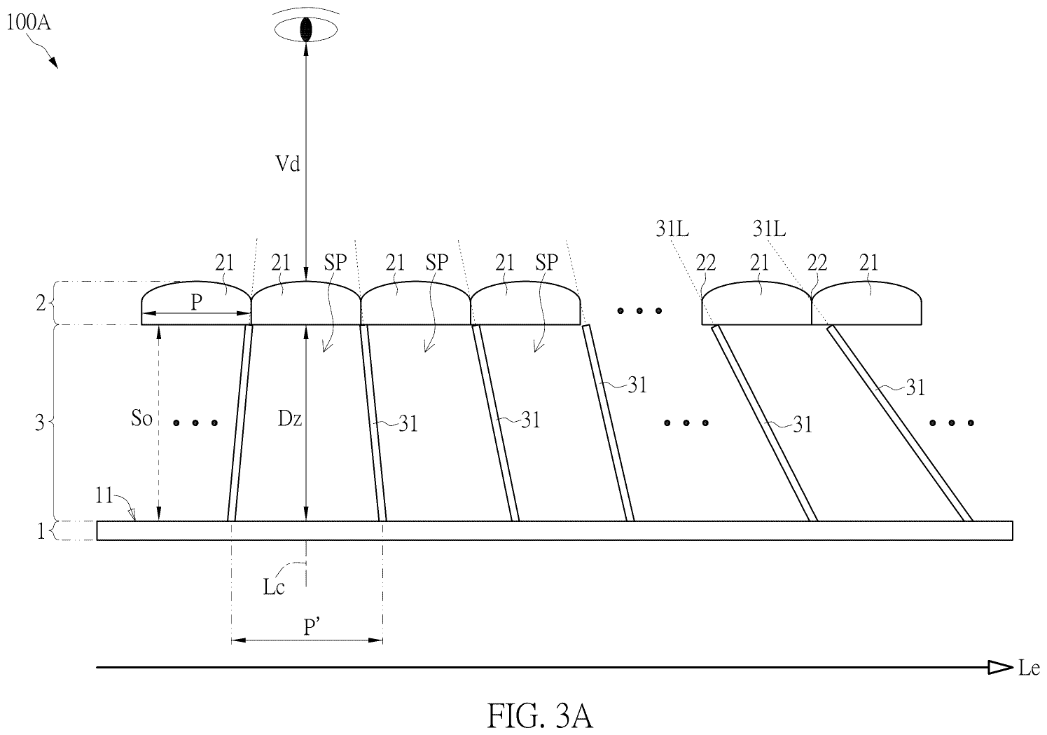

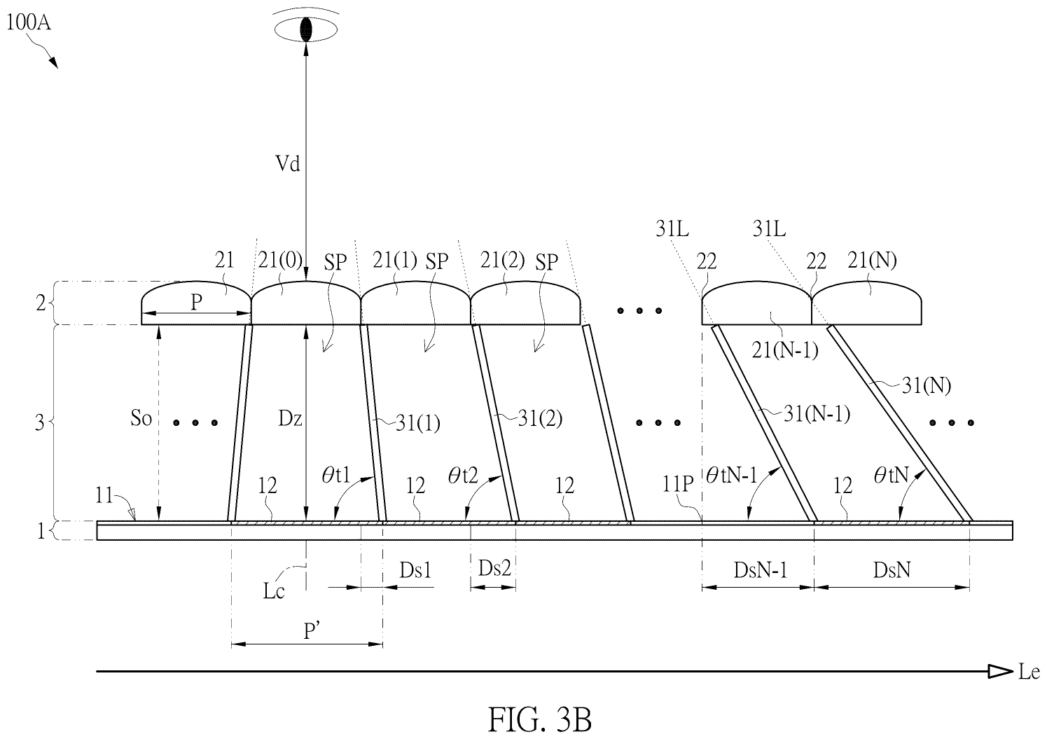

Referring to FIGS. 3 to 7, to achieve the above objectives, a first embodiment of the present disclosure provides a stereoscopic image display device 100A, and particularly provides a stereoscopic image display device 100A based on an extended coding pitch algorithm.

The stereoscopic image display device 100A can be applied in fields such as optoelectronics, health care, military, exhibition, display, education, entertainment, and consumer electronics. The stereoscopic image display device 100A can, for example, be an active floating stereoscopic image display device, capable of displaying a stereo image above the stereoscopic image display device 100A. Furthermore, the stereoscopic image display device 100A can be set on any suitable location, such as a desktop, floor, or ceiling, during use.

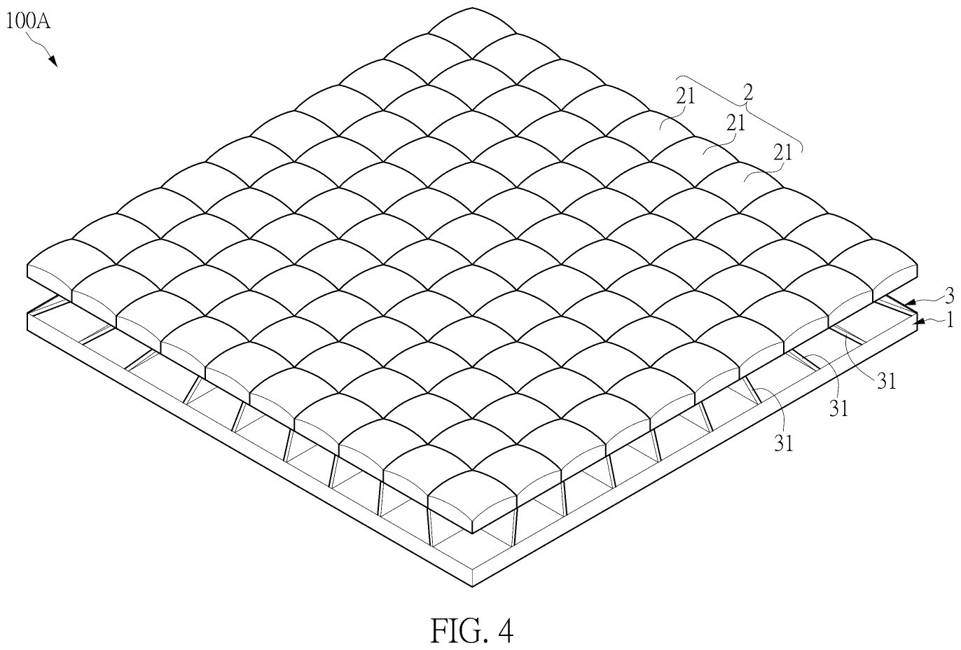

More specifically, as shown in FIGS. 3A, 3B, and 4, the stereoscopic image display device 100A includes a flat panel display unit 1, a lens array unit 2, and a directional structure 3.

The flat panel display unit 1 has a display surface 11, and the display surface 11 is configured to display a plurality of element images 12. Each of the element images 12 can be composed of one or more display pixels. The lens array unit 2 includes a plurality of condenser lenses 21. The plurality of condenser lenses 21 are connected to each other, arranged in an array, and spaced apart on one side of the display surface 11 of the flat panel display unit 1.

As shown in FIG. 3B, the condenser lens 21 located on a central axis Lc of the flat panel display unit 1 is defined as a zeroth lens 21(0), and the other condenser lenses 21 are sequentially defined as a first lens 21(1), a second lens 21(2), up to an (N−1)th lens 21(N−1) and an Nth lens 21(N) along an extension direction Le (i.e., the X direction) away from the central axis Lc.

The plurality of condenser lenses 21 are able to regulate light field. In the present embodiment, the condenser lenses 21 are plano-convex lenses with their convex surfaces directed away from (e.g., upwards) the flat panel display unit 1. More specifically, as shown in FIG. 4, the condenser lenses 21 are quadrilateral plano-convex lenses arranged in a two-dimensional matrix, but the present disclosure is not limited thereto.

Furthermore, the material of the condenser lenses 21 is selected from a group consisting of glass with better light transmission, polymethyl methacrylate (PMMA), polycarbonate (PC), and polyethylene (PE), but the present disclosure is not limited thereto.

Referring to FIGS. 3A, 3B, and 4, the directional structure 3 is disposed between the flat panel display unit 1 and the lens array unit 2. The directional structure 3 includes a plurality of partition walls 31, 31(1), 31(2), to 31(N−1), 31(N). The plurality of partition walls 31 are disposed between the display surface 11 of the flat panel display unit 1 and the plurality of condenser lenses 21 of the lens array unit 2, and the plurality of partition walls 31 are configured to define a plurality of isolated spaces SP.

As shown in FIGS. 3A and 3B, viewed from a side view of the stereoscopic image display device 100A, the plurality of isolated spaces SP respectively correspond in position to the plurality of condenser lenses 21.

When the display surface 11 of the flat panel display unit 1 displays a plurality of element images 12, the plurality of isolated spaces SP also respectively correspond to the plurality of element images 12. In other words, any two adjacent partition walls 31 of the plurality of partition walls 31 correspond to two convex boundaries 22 of two sides of one of the condenser lenses 21, so as to separate and define an isolated space SP.

Moreover, the plurality of partition walls 31 are respectively inclined between the display surface 11 of the flat panel display unit 1 and the plurality of condenser lenses 21 of the lens array unit 2.

More specifically, the plurality of partition walls 31 are respectively inclined at different angles between the display surface 11 of the flat panel display unit 1 and the plurality of condenser lenses 21 of the lens array unit 2. The end of each of the partition walls 31 near the lens array unit 2 (e.g., the top end) is directed towards one of the convex boundaries 22 of the corresponding condenser lens 21 (e.g., the convex boundary 22 of the condenser lens 21 near the central axis Lc of the flat panel display unit 1), and a virtual extension line 31L of each of the partition walls 31 extending towards the lens array unit 2 crosses the convex boundary 22.

Ends (e.g., bottom ends) of the plurality of partition walls 31 close to the flat panel display unit 1 are disposed and abutted against the display surface 11 of the flat panel display unit 1 (or the bottom ends of the partition walls 31 do not abut against the display surface 11, but the virtual extension lines 31L of the bottom ends thereof intersect the display surface 11).

The bottom ends of the plurality of partition walls 31 are shifted along the extension direction Le (i.e., the X direction) away from the central axis Lc of the flat panel display unit 1 relative to the top ends of the partition walls 31, such that a plurality of shift distances Ds1, Ds2, to DsN−1, DsN are formed. In addition, the plurality of partition walls 31 and the display surface 11 correspondingly include a plurality of included angles θt1, θt2, to θtN−1, θtN.

It should be noted that, in the present embodiment, each of the shift distances Ds1, Ds2, to DsN−1, DsN is defined by a distance between a projection point 11P, which is generated by a vertical projection of the intersection point where the virtual extension line 31L of the corresponding partition wall 31 crosses the convex boundary 22 of the corresponding condenser lens 21 to the display surface 11 of the flat panel display unit 1, and the end (e.g., the bottom end) of the partition wall 31 that is disposed and abutted against the display surface 11. In other words, the shift distance is the distance between the projection point 11P and the bottom end of the corresponding partition wall 31 (or the intersection point of the bottom end of the virtual extension line 31L with the display surface 11).

Furthermore, in the embodiment of the present disclosure, the plurality of shift distances Ds1, Ds2, to DsN−1, DsN are different from each other and gradually increase from the central axis Lc towards the extension direction Le.

Additionally, the plurality of included angles θt1, θt2, to θtN−1, θtN are also different from each other. Corresponding to the plurality of shift distances Ds1, Ds2, to DsN−1, DsN, the plurality of included angles θt1, θt2, to θtN−1, θtN gradually decrease from the central axis Lc towards the extension direction Le (e.g., gradually decreasing from approximately 90 degrees to 30 degrees).

In other words, inclined degrees of the plurality of partition walls 31 (i.e., 31(1), 31(2), to 31(N−1), 31 (N)) gradually increase towards the extension direction Le relative to the central axis Lc.

In the embodiment of the present disclosure, each of the partition walls 31 is made of light-absorbing material. For example, each of the partition walls 31 has a visible light transmittance of not greater than 10%, preferably not greater than 5%, and more preferably not greater than 1%; and has a light reflectance of not greater than 40%, preferably not greater than 30%, and more preferably not greater than 20%.

That is, most of the light emitted by each element image 12 generated on the display surface 11 can travel within the corresponding isolated space SP and be condensed by the corresponding condenser lens 21, rather than penetrating the partition wall 31 into the adjacent isolated space SP, thereby reducing the issue of light crosstalk.

It is worth mentioning that the above-mentioned visible light transmittance can be tested according to ASTM D1003 “Standard Test Method for Haze and Luminous Transmittance of Transparent Plastics,” and the above-mentioned reflectance can be tested according to ASTM F1252-21 “Standard Test Method for Measuring Optical Reflectivity of Transparent Materials,” but the present disclosure is not limited thereto.

Furthermore, in the embodiment of the present disclosure, a wall thickness of each of the partition walls 31 is not greater than 300 micrometers, preferably between 0.1 micrometers and 200 micrometers, and more preferably between 1 micrometer and 200 micrometers. The wall thickness of each of the partition walls 31 within the above range can effectively block the light emitted by the element image 12 and avoid the shadow of the partition walls in the stereoscopic image that is finally formed.

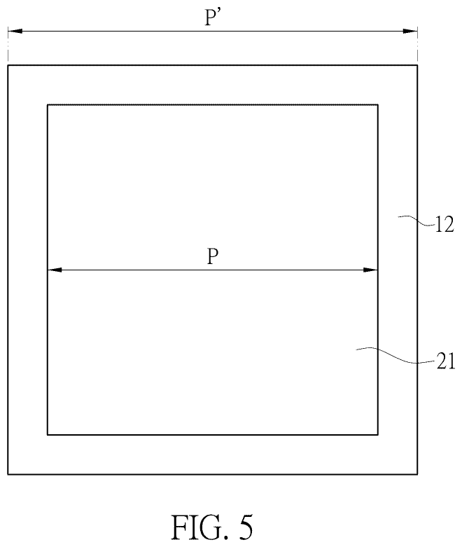

Referring to FIGS. 3A, 3B and 5, a width of each of the condenser lenses 21 is defined as a lens pitch P, and a width of each of the element images 12 displayed on the display surface 11 is defined as a coding pitch P′.

The coding pitch P′ is greater than the lens pitch P, and the coding pitch P′ is calculated based on an extended coding pitch algorithm.

In the present embodiment, the coding pitch P′ is a function of the lens pitch P, and the coding pitch P′ satisfies the following formula (1):

$$coding pitch {P}^{′} = \frac{\begin{matrix}( lens pitch P ) ( viewing distance V d + \\ equivalent object distance So )\end{matrix}}{viewing distance V d} . \qquad formula ( 1 )$$

The viewing distance Vd is a viewing distance of a user, which is a vertical distance from the user's eye to the top of the condenser lens 21 located on the central axis Lc of the lens array unit 2 (as shown in FIG. 3B).

The equivalent object distance So is a distance calculated by equating one or more medium layers disposed between the bottom of any condenser lens 21 of the lens array unit 2 and the display surface 11 of the flat panel display unit 1 to an air layer.

More specifically, the equivalent object distance So is a total optical path length by adjusting the refractive index of the distance (i.e., the thickness of the dielectric layers) from the display surface 11 of the flat display unit 1 to the bottom of the condenser lens 21 of the lens array unit 2 in the stereoscopic image display device 100A. The equivalent object distance So includes one or more light-transmitting layers between the display surface 11 and the condenser lens 21, with the physical thickness and refractive index of each light-transmitting layer jointly determining the effective propagation distance of light within the layers. In the case of a single light-transmitting layer, the equivalent object distance So is the physical thickness of the light-transmitting layer divided by the refractive index thereof.

In the case of multiple light-transmitting layers, the equivalent object distance So is the sum of the values obtained by dividing the physical thicknesses of the light-transmitting layers by the corresponding refractive index. The calculation method considers the different effects of each medium on the speed of light, ensuring that the optical path design can accommodate precise focusing needs from the flat display surface to the condenser lens.

If the medium layer is a single layer and is air, the equivalent object distance So equals an actual physical distance Dz between the bottom of the condenser lens 21 and the display surface 11 of the flat panel display unit 1.

In a specific embodiment of the present disclosure, assuming that the lens pitch P of the condenser lens 21 is 5 millimeters (mm), the equivalent object distance So is 17.78 millimeters, and the viewing distance Vd is 1.5 meters (m), which is equal to 1,500 millimeters. The calculated result of the coding pitch P′ is 5.0593 millimeters, which is slightly greater than the lens pitch P of 5 millimeters.

In the present embodiment, the zeroth lens 21(0) and the element image 12 located on the central axis Lc have a common center point. That is, the center point of the zeroth lens 21(0) and the center point of the element image 12 are located on the central axis Lc (as shown in FIG. 3B), but the present disclosure is not limited thereto. For example, the center point of the zeroth lens corresponds to a junction of two pixels of the element image 12.

Furthermore, the plurality of element images 12 other than the element image 12 located on the central axis Lc are sequentially arranged along the extension direction Le according to the calculated coding pitch P′ as described above. Therefore, the plurality of element images 12 are unaligned with the plurality of condenser lenses 21, respectively.

In other words, except that the condenser lens 21 and the element image 12 located on the central axis Lc have a common center point, the other condenser lenses 21 and their corresponding element images 12 do not have a common center point.

Referring to FIG. 3B, the plurality of partition walls 31 are sequentially defined as a first wall 31(1), a second wall 31(2), up to an (N−1)th wall 31(N−1) and an Nth wall 31(N) from the central axis Lc of the display surface 11 towards the extension direction Le (i.e., the X direction). The shift distances Ds1, Ds2, to DsN−1, DsN of the plurality of partition walls 31 are different from each other, and the shift distance Dsn of each of the partition walls 31 satisfies the following formula (2):

$$shift distance Dsn = ( n - 1 ) ( coding pitch {P}^{′} - lens pitch P ) + \frac{( coding pitch {P}^{′} - lens pitch P )}{2} . \qquad formula ( 2 )$$

In addition, n is a positive integer between 1 and N. When n=1, Dsn is Ds1, which represents the calculated shift distance for the first wall 31(1). When n=2, Dsn is Ds2, which represents the calculated shift distance for the second wall 31(2).

When n=N−1, Dsn is DsN−1, which represents the calculated shift distance for the (N−1)th wall 31(N−1). When n=N, Dsn is DsN, which represents the calculated shift distance for the Nth wall 31(N). In other words, the shift distance Dsn of each of the partition walls 31 is a function of the arrangement position, the lens pitch P, and the coding pitch P′.

In the present embodiment, the number of N satisfies the following relationship: (a short side length of the display surface 11/40 mm)<N< (a long side length of the display surface 11/0.02 mm), but is not limited thereto. The number of N can be varied according to actual design of the product.

Further, the included angles θt1, θt2, to θtN−1, θtN between the partition walls 31 and the display surface 11 of the flat panel display unit 1 are different from each other, and the included angle θtn between each of the partition walls 31 and the display surface 11 satisfies the following formula (3):

$$included angle θ tn = arctan ( \frac{physical distance Dz}{shift distance Dsn} ) . \qquad formula ( 3 )$$

The physical distance Dz is an actual distance (i.e., an actual physical vertical distance) between the bottom of the condenser lenses 21 of the lens array unit 2 and the display surface 11 of the flat panel display unit 1. If there are multiple optical layers, the physical distance Dz is the sum of the actual physical thicknesses of the multiple optical layers. Additionally, the mathematical symbol “arctan” is the arctangent function.

For example, n is a positive integer between 1 and N. When n=1, θtn is θt1, which represents the calculated included angle between the first wall 31(1) and the display surface 11. When n=2, θtn is θt2, which represents the calculated included angle between the second wall 31(2) and the display surface 11. When n=N−1, θtn is θtN−1, which represents the calculated included angle between the (N−1)th wall 31(N−1) and the display surface 11. When n=N, θtn is θtN, which represents the calculated included angle between the Nth wall 31(N) and the display surface 11.

In other words, the included angle θtn between each of the partition walls 31 and the display surface 11 is a function of the physical distance Dz and the shift distance Dsn.

According to the above configuration, the plurality of isolated spaces SP defined by the plurality of partition walls 31 can guide the light beams of the plurality of element images 12 generated by the display surface 11 to the plurality of condenser lenses 21 respectively and independently.

The stereoscopic image display device 100A of the embodiment of the present disclosure can effectively eliminate the issues of image stepping or crosstalk through the design of the directional structure 3, expand the viewing range of the image system, improve image quality, and enhance the viewing experience for the user. The stereoscopic image display device 100A of the embodiment of the present disclosure allows users to see clear and high-quality stereoscopic images even from short viewing distances or wide viewing angles.

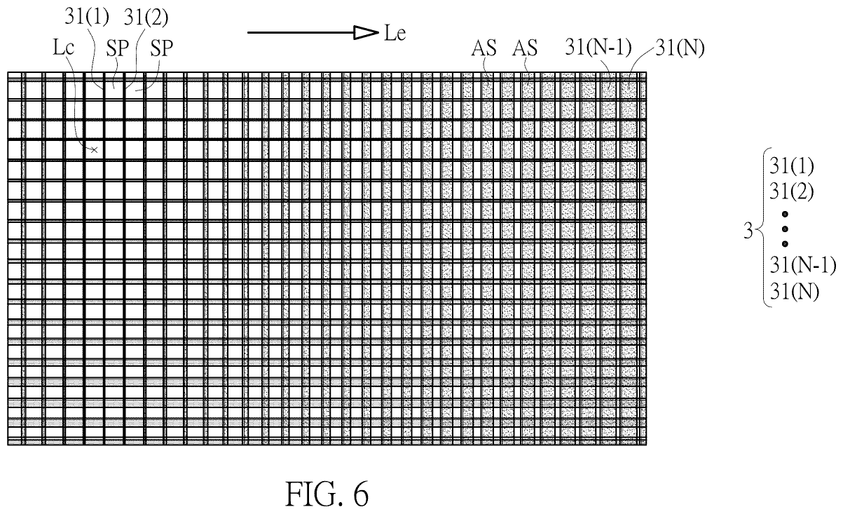

Referring to FIG. 6, FIG. 6 shows a top view of the directional structure 3 of the first embodiment of the present disclosure. Corresponding to the plurality of condenser lenses 21 arranged in a two-dimensional matrix (e.g., quadrilateral plano-convex lenses shown in FIG. 4), the plurality of partition walls 31(1), 31(2), to 31(N−1), 31 (N) of the directional structure 3 are arranged in an interleaved manner to form a directional grid structure, separating a plurality of isolated spaces SP arranged in a two-dimensional matrix corresponding to the plurality of condenser lenses 21, but the present disclosure is not limited thereto.

It is worth mentioning that a plurality of shadow areas As (indicated by shaded areas As in FIG. 6) projected on the display surface 11 by the plurality of partition walls 31(1), 31(2), to 31(N−1), 31 (N) also gradually increases correspondingly due to the increasing inclination degrees relative to the central axis Lc towards the extension direction Le.

It is worth mentioning that when the stereoscopic image display device 100A is operated, the light beams emitted by the plurality of element images 12 on the display surface 11 of the flat panel display unit 1 can produce an integral image. The light beams of the integral image can sequentially pass through the directional structure 3 and the lens array unit 2. The lens array unit 2 is configured to reassemble the integral image in a space above the stereoscopic image display device 100A to form a stereoscopic image.

Furthermore, the flat panel display unit 1 is used to display patterns of integral photography technology, and the flat panel display unit 1 further includes a computing element (not shown in the figure) to execute the algorithm. The integral image displayed on the display surface 11 of the flat panel display unit 1 is generated by calculating and redrawing a stereoscopic image, but the present disclosure is not limited thereto.

In some embodiments of the present disclosure, the display surface 11 of the flat panel display unit 1 can be, for example, a display panel of an active flat panel display.

For example, the display surface 11 of the flat panel display unit 1 can be, for example, the display panel of a smartphone, the display panel of a tablet, or the display panel of a flat screen. The type and structure of the flat panel display unit 1 is not limited by the present disclosure. A characteristic of the flat panel display unit 1 is its ability to control the switching of stereoscopic images to achieve effects of dynamic image display.

In some embodiments of the present disclosure, the display surface 11 of the flat panel display unit 1 can also be, for example, a planar pattern of a passive flat panel display, which can only display a static pattern and cannot arbitrarily change the image screen.

For example, the flat panel display unit 1 can be a lightbox drawing device, a photomask engraving device, or a printing drawing device that can only display a static pattern.

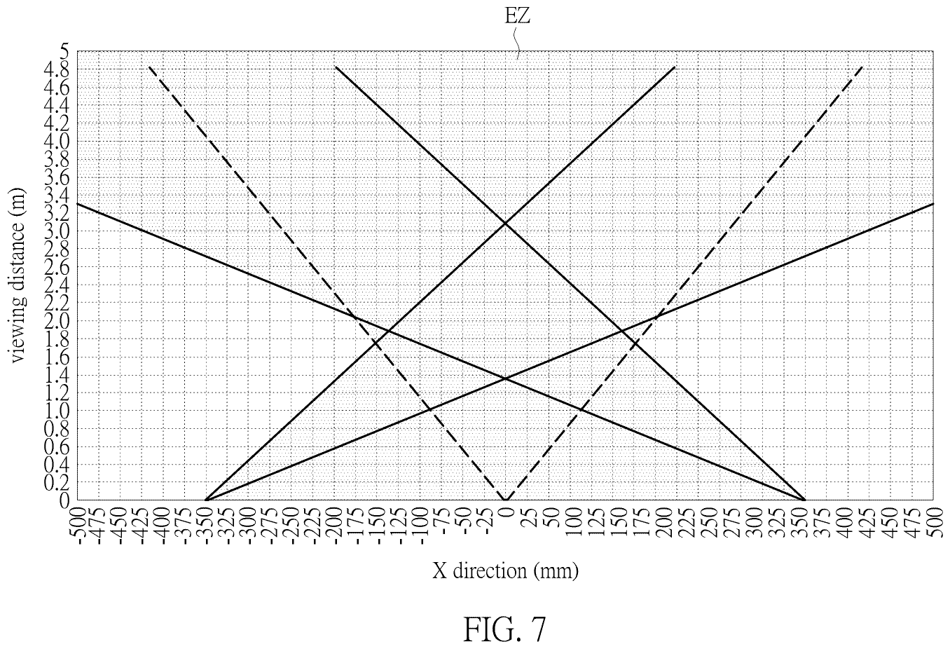

Referring to FIG. 7, FIG. 7 shows a schematic view of light distribution of the stereoscopic image display device 100A according to the first embodiment of the present disclosure. The light distribution is calculated using mathematical software (e.g., Matlab) for ray tracing. First, the two lenses at the edge of the screen are tracked, which starts from both ends of the panel unit image, and then through the medium layers and each optical element layer (including lenses and the final outgoing lens). Accordingly, the viewing angles at the far left and far right in space (viewing zone) can be obtained. In traditional systems, the intersection region of the two viewing angles forms the eye zone. Within the eye zone, the correct image can be seen by the user, while outside the eye zone, the human eye will see incorrect images (including crosstalk images).

FIG. 7 shows that the light distribution generated by the stereoscopic image display device 100A of the first embodiment of the present disclosure has a wider viewing area EZ compared to that of the conventional art, which can be applied to shorter viewing distances and larger viewing angles.

It is worth mentioning that in the present embodiment, the included angle θtn between each of the partition walls 31 and the display surface 11 is a function of the physical distance Dz and the shift distance Dsn, and the shift distance Dsn changes along with the viewing distance Vd.

Therefore, in one embodiment of the present disclosure, the included angle θtn between each of the partition walls 31 and the display surface 11 can be a fixed value based on a preset viewing distance Vd. For example, the partition walls 31 can be manufactured by 3D printing according to the calculated shift distances Dsn (Ds1, Ds2, to Ds (N−1), Ds (N)) and the included angles θtn (θt1, θt2, to θt(N−1), θt(N)).

In other embodiments of the present disclosure, the included angle θtn between each of the partition walls 31 and the display surface 11 can be dynamically changed along with the viewing distance Vd (e.g., made using liquid crystal technology or controlled by electromechanical methods), but the present disclosure is not limited thereto.

### Second Embodiment

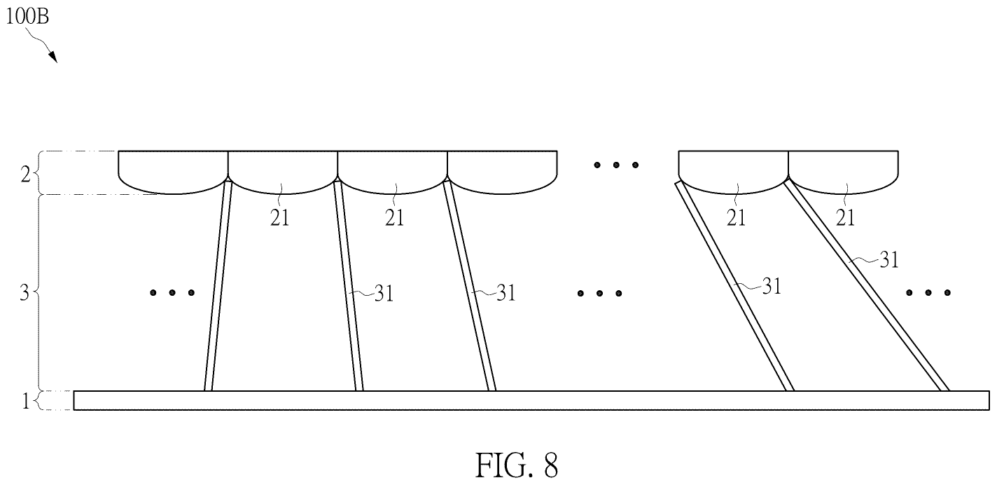

Referring to FIG. 8, a second embodiment of the present disclosure provides a stereoscopic image display device 100B, which is substantially the same as the stereoscopic image display device 100A of the first embodiment described above. The difference is that the plurality of condenser lenses 21 of the second embodiment are plano-convex lenses with their convex surfaces directed (downward) towards the flat panel display unit 1.

### Third Embodiment

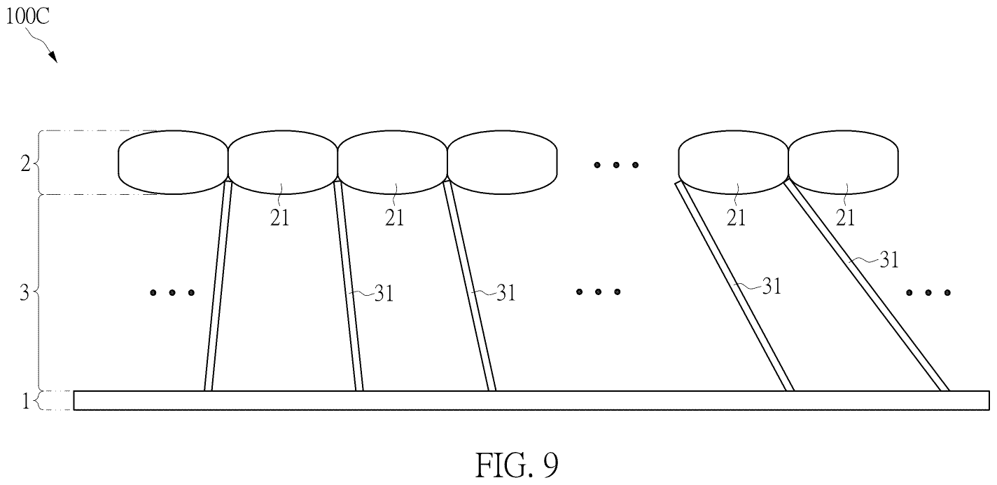

Referring to FIG. 9, a third embodiment of the present disclosure provides a stereoscopic image display device 100C, which is substantially the same as the stereoscopic image display device 100A of the first embodiment described above. The difference is that the plurality of condenser lenses 21 of the third embodiment are biconvex lenses, with both convex surfaces being directed towards and away from the flat panel display unit 1 (i.e., directed upwards and downwards), respectively.

### Fourth Embodiment

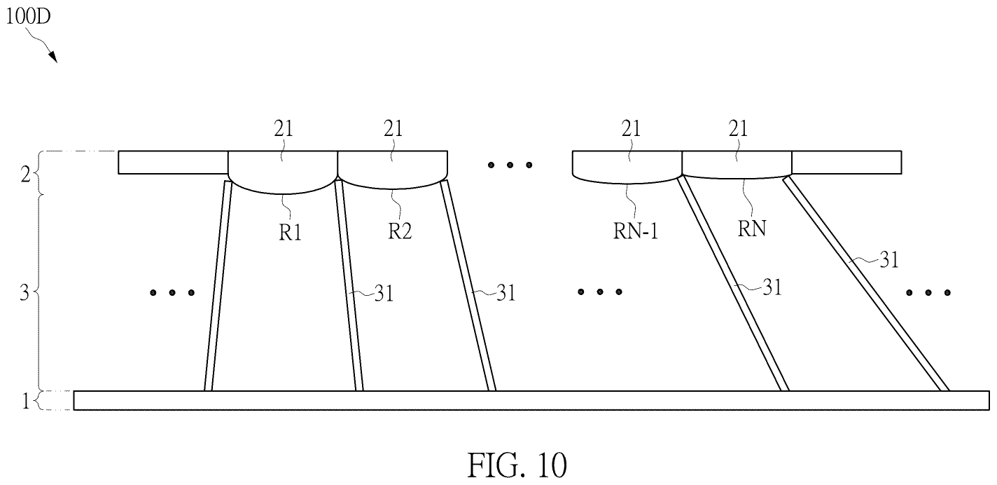

Referring to FIG. 10, a fourth embodiment of the present disclosure provides a stereoscopic image display device 100D, which is substantially the same as the stereoscopic image display device 100B of the second embodiment described above. The difference is that the convex surfaces of the plurality of condenser lenses 21 respectively have a plurality of curvature radii R1, R2, to RN−1, RN. The plurality of curvature radii R1, R2, to RN−1, RN are different from each other and gradually increase from the central axis Lc towards the extension direction Le, that is, RN>RN−1>R2>R1.

### Fifth Embodiment

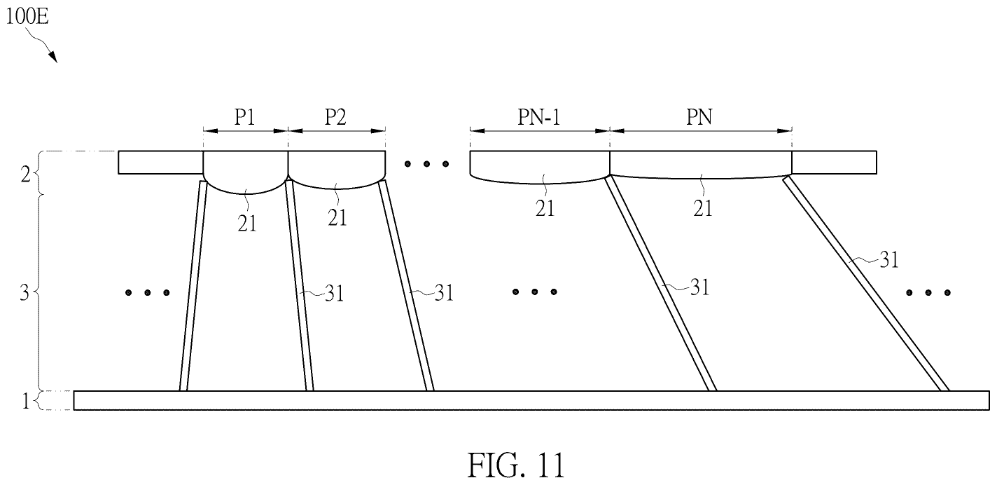

Referring to FIG. 11, the fifth embodiment of the present disclosure provides a stereoscopic image display device 100E, which is substantially the same as the stereoscopic image display device 100D of the fourth embodiment described above. The difference is that the convex surfaces of the plurality of condenser lenses 21 respectively have a plurality of lens pitches P1, P2, to PN−1, PN. The plurality of lens pitches P1, P2, to PN−1, PN are different from each other and gradually increase from the central axis Lc towards the extension direction Le, that is, PN>PN−1>P2>P1.

### Sixth Embodiment

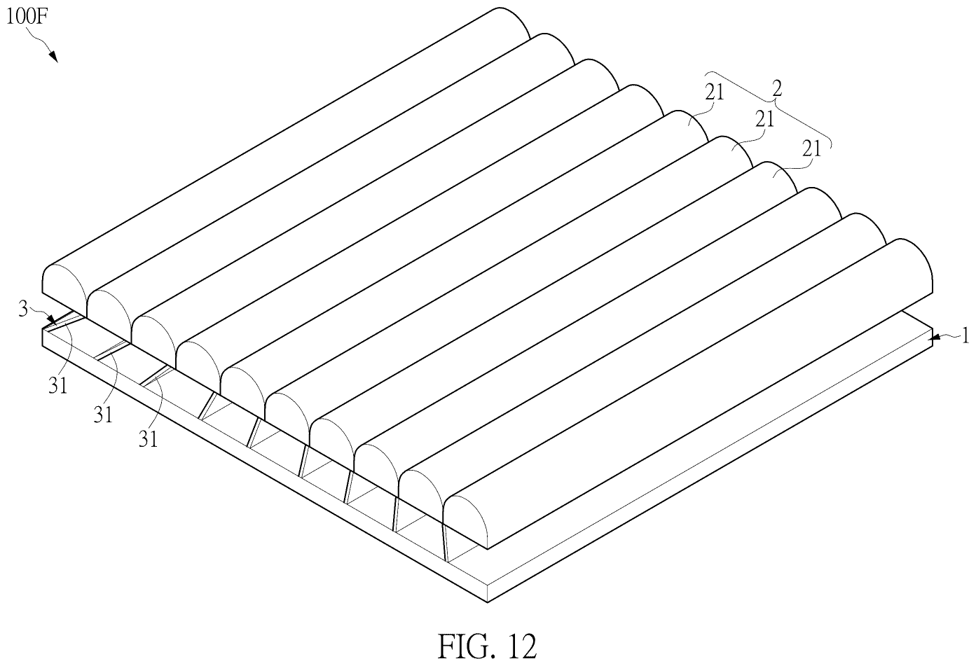

Referring to FIG. 12, a sixth embodiment of the present disclosure provides a stereoscopic image display device 100F, which is substantially the same as the stereoscopic image display device 100A of the first embodiment described above. The difference is that the plurality of condenser lenses 21 are lenticular lenses, and the plurality of lenticular lenses are arranged in a one-dimensional array and are parallel to each other.

In addition, in an unillustrated embodiment of the present disclosure, the plurality of condenser lenses 21 can also be hexagonal plano-convex lenses arranged in a two-dimensional interleaved pattern. Alternatively, the plurality of condenser lenses 21 can be aspherical lenses, such as Fresnel lenses. The condenser lenses 21 can also be a combination or any variation of the above-mentioned embodiments. The present disclosure does not limit the structure and type of lenses.

Furthermore, in other unillustrated embodiments of the present disclosure, a length of each of the partition walls 31 can be reduced so as not to cover the height between the flat panel display unit 1 and the lens array unit 2. For example, a top edge of each of the partition walls 31 can be in contact with the edge of the corresponding condenser lens 21 (i.e., the convex boundary 22), while a bottom edge thereof is not in contact with the display surface 11 of the flat panel display unit 1.

Moreover, each of the isolated spaces SP can correspond to one condenser lens 21 or simultaneously correspond to two or more condenser lenses 21, and the present disclosure is not limited thereto.

Additionally, the material of each of the partition walls 31 can block light physically or optically (e.g., using liquid crystal technology).

### Beneficial Effects of the Embodiments

In conclusion, the stereoscopic image display device provided by the present disclosure can effectively eliminate the issues of image stepping or crosstalk in the light field system of the stereoscopic image display device by virtue of “a directional structure including a plurality of partition walls, in which the plurality of partition walls are respectively inclined at different angles between the flat panel display unit and the lens array unit, and define a plurality of isolated spaces.” In addition, the stereoscopic image display device provided by the present disclosure has expanded viewing range of the image system, improved image quality, and enhanced viewing experience for the user. The stereoscopic image display device of the present disclosure allows users to see clear and high-quality stereoscopic images even from short viewing distances or wide viewing angles.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A stereoscopic image display device, comprising:
a flat panel display unit having a display surface configured to display a plurality of element images;
a lens array unit disposed at intervals on a side of the display surface and including a plurality of condenser lenses; and
a directional structure including a plurality of partition walls, wherein the plurality of partition walls are inclined at different angles between the flat panel display unit and the lens array unit, and define a plurality of isolated spaces.

2. The stereoscopic image display device according to claim 1, wherein inclined degrees of the plurality of partition walls gradually increase relative to a central axis of the display surface along an extension direction away from the central axis.

3. The stereoscopic image display device according to claim 2, wherein the plurality of isolated spaces respectively correspond to the plurality of condenser lenses, and an end of each of the partition walls close to the lens array unit is directed towards a convex boundary of the corresponding condenser lens near the central axis, and a virtual extension line of each of the partition walls extending towards the lens array unit crosses the convex boundary.

4. The stereoscopic image display device according to claim 2, wherein an end of each of the partition walls close to the flat panel display unit is disposed and abutted against the display surface, and shifted towards the extension direction away from the central axis, such that the plurality of partition walls form a plurality of shift distances, and the plurality of partition walls respectively have a plurality of included angles with the display surface.

5. The stereoscopic image display device according to claim 4, wherein the plurality of shift distances gradually increase from the central axis towards the extension direction, and the plurality of included angles gradually decrease from the central axis towards the extension direction, such that the inclined degrees of the plurality of partition walls gradually increase towards the extension direction.

6. The stereoscopic image display device according to claim 1, wherein a wall thickness of each of the partition walls is not greater than 300 micrometers.

7. The stereoscopic image display device according to claim 1, wherein a width of each of the condenser lenses is defined as a lens pitch, and a width of each of the element images displayed on the display surface is defined as a coding pitch, wherein the coding pitch is calculated based on an extended coding pitch algorithm.

8. The stereoscopic image display device according to claim 7, wherein the coding pitch satisfies formula (1) below:
$$coding pitch {P}^{′} = \frac{\begin{matrix}( lens pitch P ) ( viewing distance V d + \\ equivalent object distance So )\end{matrix}}{viewing distance V d} ; \qquad formula ( 1 )$$
wherein P represents the the lens pitch, P′ represents the coding pitch, the viewing distance Vd is a viewing distance for a user, and the equivalent object distance So is a distance calculated by equating one or more medium layers disposed between the lens array unit and the display surface to an air layer.

9. The stereoscopic image display device according to claim 8, wherein the plurality of partition walls are sequentially defined as a first wall, a second wall, up to an (N−1)th wall and an Nth wall from the central axis of the display surface towards the extension direction, wherein the shift distances of the plurality of partition walls are different from each other, and a shift distance Dsn of each of the partition walls satisfies formula (2) below:
$$shift distance Dsn = ( n - 1 ) ( coding pitch {P}^{′} - lens pitch P ) + \frac{( coding pitch {P}^{′} - lens pitch P )}{2} ; \qquad formula ( 2 )$$
wherein n is a positive integer between 1 and N.

10. The stereoscopic image display device according to claim 9, wherein the included angles between the plurality of partition walls and the display surface are different from each other, and an included angle θtn between each of the partition walls and the display surface satisfies formula (3) below:
$$included angle θ tn = arctan ( \frac{physical distance Dz}{shift distance Dsn} ) ; \qquad formula ( 3 )$$
wherein the physical distance Dz is an actual distance from a side surface of the lens array unit facing towards the display surface to the display surface of the flat panel display unit.

11. The stereoscopic image display device according to claim 1, wherein each of the partition walls has a visible light transmittance not greater than 10% and a light reflectance not greater than 40%.
